(19) United States
(12) Patent Application Publication
(10) Pub. No.: US 2023/0107478 A1
(43) Pub. Date: Apr. 6, 2023

(54) ELECTROLYTIC COMPOSITION BASED ON SULFONIC ACID COMPRISING A PHOSPHORUS ADDITIVE

(71) Applicant: ARKEMA FRANCE, Colombes (FR)

(72) Inventors: Thierry AUBERT, Lacq (FR); Dominique PLEE, Pau (FR)

(73) Assignee: ARKEMA FRANCE, Colombes (FR)

(21) Appl. No.: 17/769,115

(22) PCT Filed: Oct. 21, 2020
(86) PCT No.: PCT/FR2020/051898

§ 371 Date: Apr. 14, 2022

(30) Foreign Application Priority Data
Oct. 24, 2019 (FR) 1911889

(51) Int. Cl. H01M 8/18

(52) U.S. Cl. CPC H01M 8/188

(57) ABSTRACT

The present invention relates to an aqueous electrolyte composition comprising a sulfonic acid, optionally sulfuric acid, redox metal ions, and at least one inorganic additive (A) comprising at least one phosphorus atom whose degree of oxidation is less than or equal to +5. The present invention also relates to an electrochemical cell comprising said electrolyte composition and an oxidation-reduction battery (also called a redox battery) comprising such a cell.

The present invention relates to an aqueous electrolyte composition comprising a sulfonic acid, optionally sulfuric acid, redox metal ions and at least one inorganic additive (A) comprising at least one phosphorus atom whose degree of oxidation is less than or equal to +5. The present invention also relates to an electrochemical cell comprising said electrolyte composition and to an oxidation-reduction battery (also called a redox battery) comprising such a cell.

The development of renewable energies, such as solar and wind energy, represents an essential challenge on a global scale. However, one of the major drawbacks of these energy sources is the fact that they are dependent on meteorological phenomena and are therefore intermittent. In order to ensure reliable supplies of energy from these new sources, it is therefore necessary to have appropriate storage means.

Among the solutions considered, redox batteries represent a promising means of storage. Thus, these rechargeable batteries store energy in chemical form and restore it in the form of electricity by means of reversible oxidation-reduction reactions, using metals in different oxidation states (in the form of metal ions in electrolyte solution). Vanadium Redox Flow Batteries (or VRFB) are particularly interesting because they allow a deep discharge (100%), have a lifespan of several tens of thousands of cycles and can store a virtually unlimited amount of energy, simply by increasing the size of the electrolyte storage tanks.

However, redox battery performance, and in particular the energy density, is generally limited by the phenomenon of metal ion precipitation. For example, in the case of vanadium batteries, V(V) ions (vanadium in degree of oxidation +5) precipitate at temperatures above about 40° C., and V(II) and V(III) ions precipitate at temperatures below about 10° C. These precipitation phenomena strongly limit the use of these batteries because they require strict temperature control in a relatively limited range, for example by an air conditioning and/or ventilation system.

Indeed, the available energy density of these batteries is directly proportional to the concentration of metal ions undergoing oxidation-reduction reactions in the electrolytic composition. The energy density is therefore limited by the maximum solubility of the metal salts or oxides in the electrolytic composition (salts or oxides which, once dissolved, are found in the form of metal ions).

Consequently, if the precipitation of metal ions in the electrolyte composition is avoided, decreased, delayed or slowed down, the maximum energy density of the redox battery is increased. In addition, the battery remains usable in more extreme conditions, notably at temperatures below 10° C. and/or above 40° C.

There is therefore a need for electrolyte compositions which make it possible to avoid, reduce, slow down or delay the precipitation of metal ions and to improve their solubility. There is also a need for electrolyte compositions which make it possible to improve the performance of redox batteries.

One of the objectives of the present invention is therefore to provide an electrolyte composition making it possible to avoid, reduce, slow down and/or delay the precipitation of metal ions undergoing oxidation-reduction reactions.

Another objective of the present invention is to provide an electrolyte composition making it possible to improve the solubility of redox metal ions and/or to improve the performance of redox batteries, in particular the energy density.

An objective of the invention is also to provide an electrolyte composition which is stable at temperatures between about 0° C. and about 60° C.

The present inventors have surprisingly discovered that the use of a sulfonic acid coupled with a phosphorus additive such as according to the invention makes it possible to avoid, reduce, slow down and/or delay the precipitation of redox metal ions, in particular vanadium ions, in an electrolyte composition.

Thus, the present inventors have discovered that the combination of a sulfonic acid and a phosphorus additive such as according to the invention makes it possible to increase the solubility of redox metal ions in an electrolyte composition.

Thus, the present invention relates to an electrolyte composition comprising:
a sulfonic acid of formula R-SO₃H, in which R represents a (C₁-C₄)alkyl or a (C₆-C₁₄)aryl optionally substituted with a (C₁-C₄)alkyl,
optionally sulfuric acid,
redox metal ions,
at least one inorganic additive (A) comprising at least one phosphorus atom whose degree of oxidation is less than or equal to +5, and
water.

The electrolyte compositions according to the invention make it possible notably to obtain more efficient batteries, in particular having an increased energy density. According to one embodiment, the energy density of the batteries such as according to the invention is between 30 and 50 Wh/L.

The batteries according to the invention may notably be used at temperatures between about 0° C. and about 60° C., preferably between about 5° C. and about 50° C.

The term “redox battery” notably refers to any battery which stores energy in chemical form and restores it in the form of electricity via oxidation-reduction reactions. These oxidation-reduction reactions involve oxidation-reduction couples or “redox couples”, notably in the form of metal ions.

More particularly in redox flow batteries, the electrochemical couples may be stored outside the battery: two tanks contain the electrolytes in the liquid state, which circulate, by means of pumps, through an ion exchange cell whose two compartments are separated by a solid membrane.

These batteries are widely known and described, for example, in “Electrochemical Energy Storage for Renewable Sources and Grid Balancing, 2015 Elsevier B.V. Chapter 17, “Redox Flow Batteries”, G. Tomazic et al., 2015, pages 309-336”.

These batteries may notably be vanadium batteries as described in WO 96/35239, titanium-manganese batteries as described in U.S. Pat. No. 9,118,064 B2, hybrid batteries with iron as described in US 2018/0013164 or zinc.

The term “energy density” of the battery means the amount of energy stored per unit mass or volume. It is generally expressed in Wh/kg or Wh/L.

The term “inorganic additive” notably means a compound not comprising any carbon atoms.

The term “(C₁-C₄)alkyl” denotes saturated aliphatic hydrocarbons which may be linear or branched and which comprise from 1 to 4 carbon atoms. The term “branched” means that an alkyl group is substituted on the main alkyl chain.

The term “(C₆-C₁₄)aryl” denotes monocyclic, bicyclic or tricyclic aromatic hydrocarbon-based compounds, in particular phenyl.

Electrolyte Composition

In the context of the invention, and unless otherwise mentioned, the terms “electrolyte composition” and “electrolytic composition” are used interchangeably.

Thus, the present invention relates to an electrolyte composition comprising:
a sulfonic acid of formula R-SO₃H, in which R represents a (C₁-C₄)alkyl or a (C₆-C₁₄)aryl optionally substituted with a (C₁-C₄)alkyl,
optionally sulfuric acid,
redox metal ions,
at least one inorganic additive (A) comprising at least one phosphorus atom whose oxidation state is less than or equal to +5, and
water.

Electrolyte(s)

The electrolyte composition is notably in the form of a solution, preferably an aqueous solution, more preferentially an acidic aqueous solution.

The electrolyte compositions are preferably liquid and/or stable at a temperature of between 0° C. and 60° C., preferably between 5° C. and 50° C.

In particular, the sulfonic acid is present in said composition at a molar concentration of between 0.08 M and 8 M, preferably between 0.1 M and 4 M.

In particular, sulfuric acid is present in said composition at a molar concentration of between 0.08 M and 8 M, preferably between 0.1 M and 4 M.

Thus, the sulfonic acid and possibly the sulfuric acid are preferentially diluted with the necessary amount of water to obtain the molar concentration targeted in the electrolyte composition. They are notably in the form of an aqueous solution.

In particular, the sulfonic acid is chosen from the group consisting of: methanesulfonic acid, ethanesulfonic acid, benzenesulfonic acid, 1-naphthalenesulfonic acid, 2-naphthalenesulfonic acid and p-toluenesulfonic acid , preferably methanesulfonic acid. Preferably, the electrolyte composition according to the invention comprises sulfuric acid. A mixture of methanesulfonic acid and sulfuric acid is particularly preferred. It is possible for the sulfonic acid to be supplied as a formulation, for example under the trade name MSA LC® sold by Arkema.

In said composition, the sulfonic acid/sulfuric acid mole ratio may be between 1/99 and 99/1, preferably between 1/99 and 50/50, more preferably between 5/95 and 15/85, for example 8/92. This range of ratios makes it possible notably to obtain a battery with optimized properties, notably with a higher energy density than a battery comprising only sulfuric acid.

The methanesulfonic acid/sulfuric acid mass ratio may be between 1/99 and 50/50, preferably between 5/95 and 15/85, for example 8/92.

Inorganic Additive (A)

The electrolyte composition according to the invention comprises at least one, preferably one or two, inorganic additive(s) (A) (otherwise called mineral additive (A)) comprising at least one phosphorus atom whose degree of oxidation is less than or equal to +5.

For example, said inorganic additive (A) comprises one, two, three or six phosphorus atoms, preferably only one phosphorus atom. Said inorganic additive (A) may notably be in polymeric form, for instance polyphosphoric acids, in particular polymetaphosphoric acid.

Said degree of oxidation of the phosphorus atom may be +I, +Ill, +IV or +V. Preferably, said inorganic additive (A) is an oxoacid of phosphorus.

In particular, said additive (A) does not comprise any N-P bonds (nitrogen-phosphorus bonds). In particular, said additive (A) is not an ammonia derivative of phosphorous acid.

The salts of the inorganic additive (A) may be chosen from sodium, potassium and ammonium salts.

Said inorganic additive (A) may be chosen from the group consisting of: hypophosphorous acid (+I), phosphorous acids (+III), hypophosphoric acid (+IV), phosphoric acids (+V), polyphosphoric acids (+V), salts thereof and mixtures thereof. More particularly, said inorganic additive (A) is chosen from the group consisting of: hypophosphorous acid (+I), metaphosphorous acid (+III), pyrophosphorous acid (+III), orthophosphorous acid (+III), hypophosphoric acid (+IV), metaphosphoric acid (+V), pyrophosphoric acid (+V), orthophosphoric acid (+V), triphosphoric acid (+V), salts thereof, sodium hexametaphosphate (+V) and mixtures thereof.

Said inorganic additive (A) may be chosen from the group consisting of: hypophosphorous acid (+I), hypophosphoric acid (+IV), metaphosphoric acid (+V), pyrophosphoric acid (+V), orthophosphoric acid (+V), triphosphoric acid, (+V), the sodium, potassium and ammonium salts thereof and sodium hexametaphosphate (+V). Preferably, said inorganic additive (A) is chosen from the group consisting of: hypophosphorous acid (+I), orthophosphorous acid (+III), metaphosphoric acid (+V), pyrophosphoric acid (+V), orthophosphoric acid (+V), sodium hexameta- and tri-phosphate (+V), tripotassium phosphate (+V), mono- and di-ammonium phosphates (+V) and mixtures thereof.

Particularly preferably, said inorganic additive (A) is chosen from sodium hexameta- and tri-phosphate (+V), tripotassium phosphate (+V) and mono- and di-ammonium phosphates (+V).

The amount of inorganic additive(s) (A) may be less than or equal to 5% by weight, preferably between strictly greater than 0 and 5% by weight, for example between 0.5% and 5% by weight relative to the total weight of the electrolyte composition. Preferably, the amount of inorganic additive(s) (A) is between 0.5% and 3% by weight relative to the total weight of the electrolyte composition.

Redox Metal Ions

The electrolyte composition comprises metal ions, which are notably obtained from salts or metal oxides dissolved in the electrolyte composition. The metal ions used notably form redox couples in the electrolytic composition. According to the present invention, the terms “metal ions”, “redox ions” and “redox metal ions” are interchangeable and notably correspond to the metal ions undergoing oxidation-reduction reactions allowing the implementation of the electrochemical cell and/or the battery as defined below.

The molar concentration of redox metal ions in the electrolyte composition may be between 0.1 and 15 mol/l, preferably between 1 and 10 mol/l, preferentially between 1.6 and 5 mol/l. For example, the molar concentration of redox metal ions in the electrolyte composition is about 3, 4 or 5 mol/L. The electrolytic compositions according to the invention may be compositions supersaturated with redox metal ions. The redox metal ions may notably be chosen from the group consisting of the following ions:

Mn²⁺, Mn³⁺, Ti³⁺, TiO²⁺, Fe²⁺, Fe³⁺, V²⁺, V³⁺, VO²⁺, VO₂₊, Zn²⁺, Ce³⁺, Ce⁴⁺ and mixtures thereof.

The redox couples that may be involved in the electrolytic compositions are the following:

Mn²⁺/Mn³⁺, Ti³⁺/ TiO²⁺, Fe²⁺/Fe, Fe²⁺/Fe³⁺, V²⁺/V³⁺, VO²⁺NO²⁺, Zn²⁺/Zn and Ce³⁺/Ce⁴⁺.

Most particularly preferably, the metal ions are vanadium ions, preferentially chosen from the group consisting of: V²⁺, V³⁺, VO²⁺, VO²⁺ and mixtures thereof.

According to one embodiment, the electrolyte composition in which the anode is located comprises the ions V²⁺ and V³⁺ and the electrolyte composition in which the cathode is located comprises the ions VO²⁺ and VO²⁺.

According to one embodiment, the electrolyte composition in which the anode is located comprises the ions Ti³⁺ and TiO²⁺ and the electrolyte composition in which the cathode is located comprises the ions Mn²⁺ and Mn³⁺.

According to one embodiment, the electrolyte composition in which the anode is located comprises Fe²⁺ ions and the electrolyte composition in which the cathode is located comprises the ions Fe²⁺ and Fe³⁺ (the iron battery being a hybrid redox battery with an iron deposit at the anode).

According to one embodiment, the electrolyte composition in which the anode is located comprises Zn²⁺ ions and the electrolyte composition in which the cathode is located comprises the ions Ce³⁺ and Ce⁴⁺ (the battery being a hybrid redox battery with a zinc deposit at the anode).

Redox metal ions may be obtained following the dissolution of salts and/or corresponding metal oxides in aqueous solutions of sulfonic acid, optionally in the presence of sulfuric acid.

Thus, among the vanadium salts or oxides that may be dissolved, mention may notably be made of: ammonium metavanadate (NH₄VO₃), (NH₄V(SO₄)₂), barium pyrovanadate (Ba₂V₂O₇); bismuth vanadate (Bi₂O₃ V₂O₅); (VCs(SO₄)₂ 12H₂O); iron metavanadate (Fe(VO₂)₃); lead vanadate (Pb(VO₅)₂); potassium metavanadate (KVO₃); (KVSO₄); rubidium vanadium sulfate (RbV(SO₄)₂); sodium metavanadate (NaVO₃); vanadic acid (HVO₃); sodium metavanadate (Na₃VO₄); potassium orthovanadate (K₃VO₄); ammonium orthovanadate; sodium pyrovanadate (Na₄V₂O₇); potassium pyrovanadate (K₄V₂O₇); ammonium pyrovanadate; sodium hexavanadate (Na₄V₆O₁₇); potassium hexavanadate (K₄V₆O₁₇); ammonium hexavanadate; thallium pyrovanadate (TI₄V₂O₇); thallium metavanadate (TIVO₃); thallium pyrovanadate (TIV₂O₇ 6H₂O); vanadium pentoxide (V₂O₅); vanadium sulfate (V(SO₄)₂); vanadium oxide VO; calcium magnesium vanadate; VOCl₃.

Preferably, vanadium pentoxide or vanadium sulfate, more preferentially vanadium sulfate, is used.

It is also possible to obtain electrolyte solutions comprising vanadium ions starting from vanadyl halides, for instance vanadyl trichloride VOCl₃.

Corrosion Inhibitor

The electrolyte composition according to the invention may also comprise a corrosion inhibitor. The term “corrosion inhibitor” notably means a compound that is capable of limiting, or even preventing, the corrosion of metals by sulfonic acids such as according to the invention. Such inhibitors are notably described in patent application WO 2019/043340.

In particular, the corrosion inhibitor is chosen from the compounds of general formula (1) or (2) below:

NO₂X (1) or NO₃X (2)

in which X is chosen from:

Na;

K;

NH₄;

H; and

when the corrosion inhibitor is a compound of formula (1), then X may also be chosen from:

a linear or branched alkyl radical R′ comprising from 1 to 6 carbon atoms;

an aryl radical Ar which is optionally substituted, in particular with at least one alkyl radical R′;

a radical —SO₂-G, in which G represents H, OH, R′, OR′, OM, Ar, OAr, NH₂, NHR′ and NR′R″, in which R′ and Ar are as defined previously, R″ represents a linear or branched alkyl radical comprising from 1 to 6 carbon atoms and M represents a monovalent or divalent metal cation, preferably an alkali metal or alkaline-earth metal cation; and

a radical —CO-G, in which G is as defined previously.

When X represents a hydrogen atom, the compound of formula (1) is nitrous acid. According to a preferred embodiment of the present invention, the inhibitor is chosen from the compounds of formula (1) in which X represents —SO₂-G, and more preferably —SO₂-G where -G represents:

either —OH, in which case the corrosion inhibitor is nitrosylsulfuric acid (SHN; CAS No. 7782-78-7),

or an alkyl radical R′, preferably a methyl radical, in which case the corrosion inhibitor (CAS No. 117933-98-9) is the product of the reaction of methanesulfonic acid (or the chloride thereof) with nitrous acid.

Preferably, the corrosion inhibitor is chosen from sodium, potassium and ammonium nitrites and nitrates.

The electrolyte composition may be prepared by dissolving, preferably with stirring and/or by ultrasonication, metal salts and/or oxides in appropriate proportions of acidic aqueous solution.

For example, the electrolyte composition according to the invention may be prepared according to the following process:

a) preparing an aqueous solution of a sulfonic acid as defined above;

b) optionally mixing sulfuric acid with said aqueous solution obtained in step a);

said sulfuric acid optionally being prepared beforehand in the form of an aqueous solution;

c) adding and dissolving the inorganic additive(s) (A) to the aqueous solution obtained in step a) or obtained in step b); and

d) adding and dissolving the redox metal salts and/or oxides.

Electrochemical Cell and Battery

The present invention also relates to an electrochemical cell comprising a negative electrode, a positive electrode and an electrolyte composition as defined above, notably interposed between the negative electrode and the positive electrode. The electrochemical cell may also comprise a proton exchange membrane that is impermeable to redox metal ions, preferably impermeable to vanadium ions. Such membranes are notably known under the trade name Nafion® (for example Nafion® N115, N117) and are based on fluorinated copolymers based on sulfonated tetrafluoroethylene.

The electrolytic compositions according to the invention may be catholytes (compositions in which the cathodes are immersed) and/or anolytes (compositions in which the anodes are immersed). They are generally stored in external tanks and are pumped into each of the cathodic or anodic compartments where the cathode and the anode of the cell, respectively, are immersed. The electrochemical cells comprising the electrolyte composition as according to the invention are notably those conventionally used in the context of redox batteries, preferably redox flow batteries, more particularly vanadium redox flow batteries.

In the context of the invention, the term “negative electrode” or “anode” means the electrode which in discharge allows the oxidation of the reduced species.

In the context of the invention, the term “positive electrode” or “cathode” means the electrode which in discharge ensures the reduction of the oxidized species.

The structure of a redox battery cell notably comprises a metal frame, a current collector, a bipolar plate, a seal with its electrode, a proton-conducting membrane, a seal with its electrode, a bipolar plate, a current collector and a metal frame. Needless to say, the cells are assembled in such a way as to ensure voltage and amperage.

The present invention also relates to a redox battery, preferably a redox flow battery, comprising at least one electrochemical cell as described above. When the battery comprises several electrochemical cells according to the invention, said cells may be assembled in series and/or in parallel.

Particularly preferably, the battery according to the invention is a vanadium redox flow battery.

Uses

The invention also relates to the use of an inorganic additive (A) as defined above, for increasing the concentration of redox metal ions and/or avoiding or reducing and/or slowing down or delaying the precipitation of redox metal ions in an electrolyte composition as defined above, notably with respect to an electrolyte composition without inorganic additive (A).

The invention also relates to the use of an inorganic additive (A) as defined above for stabilizing an electrolyte composition as defined above at a temperature of between 0° C. and 60° C., preferably between 5° C. and 50° C.

The invention also relates to the use of an inorganic additive (A) as defined above for avoiding or reducing and/or delaying or slowing down the precipitation of redox metal ions, in particular vanadium ions, in an electrolyte composition as defined above, at a temperature of between 0° C. and 60° C., preferably between 5° C. and 50° C.

The invention also relates to batteries such as according to the invention for storing and restoring renewable energies, in particular solar and wind energies.

For these uses, the electrolyte composition and its constituents are as defined above for the composition, the electrochemical cell and the battery.

In the context of the invention, the term “of between x and y” or “between x and y” means an interval in which the limits x and y are included.

### EXAMPLES

### Example 1: Stability of aqueous electrolytes for vanadium redox flow batteries comprising methanesulfonic acid (MSA) and one or more phosphorus additive(s) at high and/or low temperature

The thermal stability of electrolytes for a vanadium redox flow battery comprising a mixture H₂SO₄/MSA/inorganic phosphorus additive(s) was compared with that of a conventional vanadium redox flow battery electrolyte, such as those found commercially, for example those sold by the company Oxkem (https://www.oxkem.com/_html/product_pages/vanadium_sulfate_electrolyte.html) or by the company GfE (https://www.gfe.com/en/products-and-solutions/vanadium-chemicals/product-overview), for which:

the concentration of vanadium in oxidation state +4 (V+4) is generally about 1.55-1.75M (mol/l),

the concentration of sulfuric acid (H₂SO₄) is generally about 2-3M, and

the concentration of stabilizing additive, which is usually phosphoric acid, is about 0.05M.

A series of electrolytes from 99.9% vanadyl sulfate VOSO₄, H₂O_{4.8} (V4+) from the company Alfa Aesar, 95% sulfuric acid (H₂SO₄) from the company Carl-Roth, 99.5% methanesulfonic acid from the company Arkema and 85% phosphoric acid (H₃PO₄) (Ph.Eur p.a.) in water, from the company VWR, was prepared (see table 1 below). For this, the desired adequate amount of VOSO₄ is weighed out and added to about 10 ml of water pre-acidified with the desired amount of acids (sulfuric and/or methanesulfonic and/or phosphoric) calculated for a final volume of 15 ml. The mixtures obtained are heated to 60° C. in a water bath to dissolve the vanadyl sulfate.

When dissolution is complete, the amount of water necessary to obtain 15 ml of electrolyte is added at 60° C. and allowed to cool to 20-23° C. After at least 2 days of stabilization, the concentrations of vanadium +4 and +5 are measured by cerimetric titration (see table 1 below):

TABLE 1
Composition of the vanadium (+4) electrolytes

| | | Electrolyte | Electrolyte |
|---|---|---|---|
| | Electrolyte | V + 4 | V + 4 according to |
| | reference | without | the invention with |
| | V + 4 | additive | H₃PO₄ |
| Molar concentration of | 3M | 2.75M | 2.75M |
| H₂SO₄ used for the | | | |
| dissolution of VOSO₄ | | | |
| Molar concentration of | 4.7M | 4.45M | 4.45M |
| total sulfates | | | |
| Molar concentration of | — | 0.25M | 0.25M |
| MSA | | | |
| Molar concentration of | 0.05M | — | 0.05M |
| H₃PO₄ | | | |
| Relative molar | 99.7% | 100% | 90.7% |
| concentration of V + 4 | | | |
| Relative molar | 0.3% | 0% | 0.3% |
| concentration of V + 5 | | | |
| Total molar | | | |
| concentration of | 1.7M | 1.7M | 1.7M |
| vanadium | | | |

The three electrolytes prepared above were then electrolyzed in an electrochemical cell according to a conventional method in order to obtain electrolytes V+5 and V+3 for the thermal stability tests.

On conclusion of this electrolysis, two other additives were added to electrolytes V+3 and V+5 containing MSA (but no phosphoric acid):
diammonium phosphate: 99.9% (NH₄)₂PO₄ from the company Sigma-Aldrich,
a 50/50% mass mixture of 99.9% potassium phosphate K₃PO₄ and 96% sodium hexametaphosphate (NaPO₃)ₙ from the company Sigma-Aldrich.

Finally, 1 ml of each electrolyte was placed in a small plastic tube and the samples were placed in an oven at 49-51° C. and visually inspected every day until the appearance of the first solid particles or the start of a color change, signs of electrolyte degradation. This determines the “induction time”, i.e. the stability time of the electrolyte at the temperature studied. The vanadium concentrations in the supernatant liquid are then determined to quantitatively estimate the proportion of vanadium that has precipitated.

The compositions and induction times of the various electrolytes subjected to the thermal stability tests are described in table 2 below:

TABLE 2
Induction time and composition of electrolytes V + 5 before/after thermal test
at 50° C.

| | | Electrolyte 1 | Electrolyte 2 | Electrolyte 3 |
|---|---|---|---|---|
| | | (V + 5) | (V + 5) | (V + 5) |
| | Electrolyte | according to the | according to the | according to the |
| | V + 5 | invention with | invention with | invention with |
| | reference | H₃PO₄ | K₃PO₄/(NaPO₃)ₙ | (NH₄)₂PO₄ |
| Motor concentration | — | 0.25M | 0.25M | 0.25M |
| of MSA | | | | |
| Motor concentration | 0.05M | 0.05M | — | — |
| of H₃PO₄ | | | | |
| Mass concentration | — | — | 1%/1% | — |
| of K₃PO₄/(NaPO₃)ₙ | | | | |
| Molar concentration | — | — | — | 0.1M |
| of (NH₄)₂PO₄ | | | | |
| Relative molar | 0.7% | 0.7% | 0.9% | 0.9% |
| concentration of V + 4 | | | | |
| before thermal test | | | | |
| Relative molar | 99.3% | 99.3% | 99.1% | 99.1% |
| concentration of V + 5 | | | | |
| before thermal test | | | | |
| Relative molar | 1.5% | 1.2% | 1.3% | 1.4% |
| concentration of V + 4 | | | | |
| after thermal test | | | | |
| Relative molar | 98.5% | 98.8% | 98.7% | 98.6% |
| concentration of V + 5 | | | | |
| after thermal test | | | | |
| Total molar | 1.48M | 1.64M | 1.68M | 1.70M |
| concentration of | | | | |
| vanadium after | | | | |
| thermal test | | | | |
| Induction time (days) | 5 | 6 | 18 | 14 |

The results in table 2 clearly show that the electrolytes according to the invention make it possible to significantly improve the stability of the vanadium-based electrolyte since, firstly, the total vanadium concentrations after the thermal test are not very different, or are even equal to the initial concentrations before the test (1.7 M), unlike the reference electrolyte.

Secondly, the first signs of degradation of the electrolyte appear later than for the reference electrolyte, even up to 13 days longer for electrolyte 2 according to the invention.

Moreover, the compositions H₂SO₄/MSA/Additives according to the invention also allow good stability at low temperature. It is known that the V+3 and V+2 electrolytes are the most sensitive to low temperatures. However, none of the V+3 electrolyte solutions obtained after electrolysis of the V+4 solutions showed any sign of degradation (change in color or appearance of solid particles) after 8 days at 5° C.

In summary, the electrolyte compositions according to the invention show excellent thermal stability, in particular for vanadium redox flow batteries.

1. An electrolyte composition comprising:
a sulfonic acid of formula R-SO₃H, in which R represents a (C₁-C₄)alkyl or a (C₆-C₁₄)aryl optionally substituted with a (C₁-C₄)alkyl,
optionally sulfuric acid,
redox metal ions,
at least one inorganic additive (A) comprising at least one phosphorus atom whose oxidation state is less than or equal to +5, and
water.

2. The composition according to claim 1, in which the sulfonic acid is chosen from the group consisting of: methanesulfonic acid, ethanesulfonic acid, benzenesulfonic acid, 1-naphthalenesulfonic acid, 2-naphthalenesulfonic acid and p-toluenesulfonic acid, preferably methanesulfonic acid.

3. The composition according to claim 1, comprising sulfuric acid, preferably comprising a mixture of methanesulfonic acid and sulfuric acid.

4. The composition according to claim 1, in which said inorganic additive (A) is chosen from the group consisting of: hypophosphorous acid, phosphorous acids, hypophosphoric acid, phosphoric acids, polyphosphoric acids, salts thereof and mixtures thereof.

5. The composition according to claim 1, in which said inorganic additive (A) is chosen from the group consisting of: hypophosphorous acid, metaphosphorous acid, pyrophosphorous acid, orthophosphorous acid, hypophosphoric acid, metaphosphoric acid, pyrophosphoric acid, orthophosphoric acid, triphosphoric acid, salts thereof, sodium hexametaphosphate and mixtures thereof.

6. The composition according to claim 1, in which the amount of inorganic additive(s) (A) is less than or equal to 5% by weight, preferably is comprised between 0.5% and 3% by weight, relative to the total weight of the electrolyte composition.

7. The composition according to claim 1, in which the redox metal ions are vanadium ions, preferably chosen from the group consisting of: V²⁺, V³⁺, VO²⁺, VO₂₊ and mixtures thereof.

8. The composition according to claim 1, also comprising a corrosion inhibitor.

9. The composition according to claim 8, in which the corrosion inhibitor is chosen from the compounds of general formula (1) or (2) below: NO2X (1) or NO3X (2) in which X is chosen from:
Na;
K;
NH_{4;}
H; and
when the corrosion inhibitor is a compound of formula (1), then X may also be chosen from:
a linear or branched alkyl radical R′ comprising from 1 to 6 carbon atoms;
an aryl radical Ar which is optionally substituted, in particular with at least one alkyl radical R′;
a radical —SO₂-G, where G represents H, OH, R′, OR′, OM, Ar, OAr, NH₂, NHR′ and NR′R″, in which R′ and Ar are as defined previously, R″ represents a linear or branched alkyl radical comprising from 1 to 6 carbon atoms and M represents a monovalent or divalent metal cation, preferably an alkali metal or alkaline-earth metal cation; and
a radical —CO-G, in which G is as defined previously.

10. An electrochemical cell including a negative electrode, a positive electrode and an electrolyte composition as defined in claim 1.

11. A redox battery comprising at least one electrochemical cell as claimed in claim 10, preferably a vanadium redox flow battery.

12. Use of an inorganic additive (A) comprising at least one phosphorus atom whose oxidation state is less than or equal to +5 for increasing the concentration of redox metal ions and/or avoiding or reducing and/or slowing down or delaying the precipitation of the redox metal ions in an electrolyte composition as defined in claim 1.

13. Use of an inorganic additive (A) comprising at least one phosphorus atom whose oxidation state is less than or equal to +5 for stabilizing an electrolyte composition as defined in claim 1 at a temperature of between 0° C. and 60° C., preferably between 5° C. and 50° C.
